(19) United States
(12) Patent Application Publication
(10) Pub. No.: US 2004/0159228 A1
(43) Pub. Date: Aug. 19, 2004

(54) Self-repairing armor

(76) Inventor: Solomon Budnik, Tel Aviv (IL)

Correspondence Address: SOLOMON BUDNIK, APT. 16, 8 HARZFELD ST., TEL AVIV, 67530, IL

(21) Appl. No.: 10/366,879

(22) Filed: Feb. 19, 2003

(51) Int. Cl. B32B 15/00; B32B 18/00; F41H 5/02

(52) U.S. Cl. 89/36.02; 428/408; 428/457

(57) ABSTRACT

The present invention is a double frame armor comprised of the base metal plate covered by graphite and of exterior metal plate covered by graphite and galvanized rubber. Replaceable metal sections containing reactive metal and chemical grains are sandwiched between the armored double frame—the article, constituting the double hull of a tank, armored vehicle, ship, submarine, aircraft or spacecraft. Impact of a projectile, missile, mine or meteorite on the article triggers a chemical reaction of said reactive elements effective to increase the stiffness of the armor and prevent its fracture, and sufficient to solidity into armor and patch the fracture.

### CROSS-REFERENCE TO RELATED APPLICATIONS

Not available

### STATEMENT REGARDING FEDERALLY SPONSORED RESEARCH OR DEVELOPMENT

Not available.

Reference to Sequence Listing

Not available

### BACKGROUND OF THE INVENTION

I claim: The utility invention in armor. Field of the endeavor is the advanced and improved means of armor protection for tanks, armored vehicles, ships, submarines, aircrafts and spacecrafts. Albeit several types of armor systems have been developed for protecting vehicles, ships and aircrafts from armor piercing projectiles and missiles, there is a need for a reactive armor system which constitutes the double hull of a tank, armored vehicle, ship, submarine, aircraft and spacecraft and is fully protective against projectiles, missiles and mines on earth and against missiles and meteorites in the open space. This need is fulfilled by the article.

### BRIEF SUMMARY OF THE INVENTION

Object of the invention is to provide new armor means for tanks, armored vehicles, ships, submarines, aircrafts and spacecrafts.

These means is the invented double frame armor used for the first time in tanks, armored vehicles, ships, submarines, aircrafts and spacecrafts.

The article is comprised of the armored double frame constituting the double frame of a tank, armored vehicle, ship, submarine, aircraft or spacecrafts. Metal sections containing a reactive mixture of bonded metal and chemical grains are sandwiched between the metal plates of the frame.

### DETAILED DESCRIPTION OF THE INVENTION

Generally, a tank, armored vehicle, ship, submarine, aircraft or spacecrafts has a one-part hull or one-piece cast armor. This article is an improvement, for it has advanced innovations and adjustments.

The present invention is a composite armor, integrating metal sections with reactive material providing dynamic stiffening properties to the back of the exterior armor to prevent its fracture. Said metal sections are insulated from one another so that activation of one section will not cause activation of adjacent sections. Inert graphite and galvanized rubber cover the invention. The phrase “reactive material” is defined herein to mean a material that is energetic and will react with itself under certain conditions. The term “fracture” is defined as through fracture where cracks in the exterior armor run from the top surface through to the bottom surface. The term “inert” as used herein means non-explosive material that does not react with itself or other materials.

Major innovation is that this article is a double frame armor constituting the double hull of a tank, armored vehicle, ship, submarine, aircraft or spacecraft.

The improvement is that the base frame, the inner level armor has a graphite layer to withstand temperatures of over 3000 degrees Celsius.

Additional improvement is that the exterior armor has two outer layers. First is graphite, which is many times harder and lighter than steel and can withstand thermal weapons, large blasts and atomic explosions. Said graphite layer is covered by galvanized rubber to amortize the impact of assault weapons and blasts.

Paramount advantage is that the article is a self-repairing armor due to reactive mixture of magnetized metal and chemical elements that are the contents of the vacuum-sealed, replaceable metal sections sandwiched between the armored metal plates. Said reactive elements interact and solidify into armor under the impact of projectiles, missiles, mines or meteorites, making the article impregnable. It means that any fracture in the exterior armor and the metal segment behind it is immediately patched by the impact-triggered chemical reaction, whereby said reactive elements interact with the air in the pierced armor of the vehicles and aircrafts, and with the water in the pierced armor of ships and submarines.

Ultimate advantage is that any impact on the article is counteracted at the point of the impact by reactive sections of the article that repulse the attack at the point of the impact. Upon impact, the reactive material has a reaction velocity effective to prevent the fracture of the article, and sufficient to solidify into armor upon fracture.

What I claim as my invention is:

1. Self-repairing armor.

2. Armor according to claim 1, wherein said article is comprised of an armored double frame constituting the double hull of a tank, armored vehicle, ship, submarine, aircraft or spacecraft.

3. Armor according to claim 2, wherein said double frame is comprised of the base metal plate covered by graphite, and of exterior metal plate covered by graphite and galvanized rubber.

4. Armor according to claim 3, wherein reactive mixture of bonded metal and chemical grams is contained in the vacuum-sealed, replaceable metal sections sandwiched between said metal plates of said double frame. Said reactive elements become activated by the shock waves of the impacting projectiles, missiles, mines or meteorites, and expand under exerted pressure to provide effective support to the exterior armor to restrain its fracture.

5. Armor according to claim 4, wherein said reactive elements interact and solidify into armor under the impact of projectiles, missiles, mines or meteorites, making the article impregnable, for any fracture in the exterior armor and the metal segment behind it is immediately patched by the impact-triggered chemical reaction, whereby said reactive elements interact with the air in the pierced armor of the vehicles and aircrafts, and with the water in the pierced armor of ships and submarines.

6. Armor according to claim 1, 4 and 5, wherein the impact upon said article is counteracted at the point of the impact by said reactive sections of the article that repulse the attack at the point of the impact. Upon impact, the reactive material has a reaction velocity effective to prevent the fracture of the article, and sufficient to solidify into armor upon fracture.
